(19) United States
(12) Patent Application Publication
(10) Pub. No.: US 2024/0139735 A1
(43) Pub. Date: May 2, 2024

(54) APPARATUS, DEVICE AND METHOD FOR COLLECTING, SENSING AND ANALYZING SAMPLE FLUID

(71) Applicant: Summa Finland Oy, Oulu (FI)

(72) Inventors: Tommi Kinnunen, Helsinki (FI); Juuso Nissilä, Oulu (FI); Paavo Pietola, Helsinki (FI); Wojciech Kurek, Wroclaw (PL)

(73) Assignee: Summa Finland Oy, Oulu (FI)

(21) Appl. No.: 18/486,235

(22) Filed: Oct. 13, 2023

(30) Foreign Application Priority Data
Oct. 31, 2022 (FI) 20225968

(51) Int. Cl. B01L 3/00

(52) U.S. Cl. CPC B01L 3/502715; B01L 3/54; B01L 2300/021; B01L 2300/043; B01L 2300/0627; B01L 2300/0803; B01L 2400/0463

(57) ABSTRACT

An apparatus for collecting a sample fluid includes a base part with sample well plate with cavity having plurality of holes fluidically connecting first side and second side of cavity. The cavity is configured to accommodate sample collection part of sample stick on first side of cavity. The base part has microfluidic plate configured to channelize flow of at least a part of sample fluid received via plurality of holes towards at least one sensor coupled to microfluidic plate; and plurality of electrical connectors connected to at least one sensor. Moreover, the apparatus has lid part coupled to base part, lid part having compressible region configured to receive first amount of external force thereon and exert pressure over sample collection part to enable flow of sample fluid towards at least one sensor.

### TECHNICAL FIELD

The present disclosure relates to an apparatus for collecting a sample fluid, a device for sensing and analysing data from a collected sample fluid and a method for collecting and analysing a sample fluid.

### BACKGROUND

Generally, fluids from subjects are collected for various applications such as molecular epidemiology, clinical trials and basic research studies. Examples of such fluids include blood, urine, saliva, snot, and so on. Many medical advances, including studies of heart disease, AIDS and cancer, have resulted from preliminary developmental studies, and are dependent on appropriate collection and precise use of these fluids.

Conventionally, such fluids may be collected, sensed and analyzed by using separate devices for each separate process. Typically, such arrangement requires separate collection and reading mechanisms to perform different functions with such fluids. However, a limitation of the existing solutions is that the collection and analysis of the fluid is not accurate and reliable. Moreover, the involvement of separate devices for separate functions makes the whole process complicated as well as prone to a potential contamination of the sample. Furthermore, despite the affordable and less resource extensive nature of the existing solutions, these solutions fail to analyze several properties from the collected sample of the fluid.

Therefore, in light of the foregoing discussion, there exists a need to overcome the aforementioned drawbacks associated with known techniques for collecting, sensing and analysing a sample fluid.

### SUMMARY

The present disclosure seeks to provide an apparatus for collecting a sample fluid. The present disclosure also seeks to provide a device for sensing and analysing data from a collected sample fluid. The present disclosure also seeks to provide a method for collecting and analysing a sample fluid. An aim of the present disclosure is to provide a solution that overcomes at least partially the problems encountered in the prior art.

In one aspect, an embodiment of the present disclosure seeks to provide an apparatus for collecting a sample fluid, the apparatus comprising:
a base part comprising:
   a sample well plate comprising a cavity having a one or more holes fluidically connecting an inner side of the cavity and an outer side of the cavity opposite the inner side of the cavity, when in use the cavity is configured to receive a sample fluid on the inner side of the cavity;
   a microfluidic plate configured to channelize a flow of at least a part of the sample fluid received via the one or more of holes towards at least one sensor coupled to the microfluidic plate; and
   a plurality of electrical connectors connected to the at least one sensor; and
a lid part coupled to the base part, the lid part comprising a compressible region, the compressible region is configured to receive a first amount of external force thereon and exert a pressure over the received sample fluid to enable the flow of at least a part of the sample fluid towards the at least one sensor via the one or more holes and the microfluid plate.

Optionally the microfluid plate comprises one or more microfluidic channels each arranged to deliver one or more reagents in phased order. The reagents are mixed with the sample to affect a reaction taking place in the at least one sensor. As an example, reagent can be solvent to dissolve some of the sample fluid.

In another aspect, an embodiment of the present disclosure seeks to provide a device for sensing and analyzing data from a collected sample fluid, the device comprising:
a first part having a plurality of base connectors, arranged on an inner side of the first part, to connect with a plurality of electrical connectors of at least one sensor of an apparatus mentioned above;
a second part coupled to the first part, the second part comprising an extruding part, wherein the extruding part is configured to provide a first amount of external force towards the first part when the first part and the second part are moved towards each other for a first amount of distance;
an opening arranged between the first part and the second part to receive the apparatus such that a compressible region of a lid part of the apparatus is configured to receive the first amount of external force of the extruding part when in use; and
a controller configured to obtain an indicator value related to at least one sensor of the apparatus.

Optionally the device for sensing and analyzing data comprises means to deliver one or more reagents. The reagents can be provided in a compressible, breakable ampoule or such in order to be squeezed into the at least one sensor using second or third amount of external force and guided via dedicated fluidic channels (which the channels are microfluidic). In one embodiment, needed chemical(s) may be provided in solid but soluble form such as salts.

In yet another aspect, an embodiment of the present disclosure seeks to provide a method for collecting and analysing a sample fluid, the method comprising:
receiving a sample fluid in a sample well plate of an apparatus from a sample collection part of a sample stick;
delivering at least a part of the sample fluid from the sample well plate towards at least one sensor of the apparatus when a compressible region receives a first amount of external force thereon from an extruding part of a device and exerts a pressure on the sample collection part; and
obtaining an indicator value related to the at least one sensor.

In still another aspect, an embodiment of the present disclosure seeks to provide a computer program product comprising a non-transitory computer-readable storage medium having computer-readable instructions stored thereon, the computer-readable instructions being executable by a computing device comprising a processor to execute the aforementioned method.

Embodiments of the present disclosure substantially eliminate or at least partially address the aforementioned problems in the prior art, and provide an efficient, reliable, and accurate way of collecting, sensing and analyzing sample fluids. Beneficially, the apparatus ensures an adequate amount of the sample fluid to be collected for an accurate and precise analysis thereof. Moreover, the disclosed apparatus and the device is easy to use and may be used in medical testing applications, condition (doping) analyzing in sports, health support areas, and so forth.

Additional aspects, advantages, features and objects of the present disclosure will be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1A is an exploded view of an apparatus for collecting a sample fluid in an open configuration thereof, in accordance with an embodiment of the present disclosure;

FIG. 1B is a bottom view of the apparatus for collecting the sample fluid in a closed configuration thereof, in accordance with an embodiment of the present disclosure;

FIG. 1C is a cross-sectional view of the apparatus for collecting the sample fluid in a closed configuration thereof, in accordance with an embodiment of the present disclosure;

FIG. 1D is a perspective view of accommodating a sample stick in the apparatus for collecting the sample fluid, in accordance with an embodiment of the present disclosure;

FIG. 2A is a perspective view of a device for sensing and analysing data from a collected sample fluid in an inactive mode thereof, in accordance with an embodiment of the present disclosure;

FIG. 2B is a perspective view of a device for sensing and analysing data from a collected sample fluid in an analysis mode thereof, in accordance with an embodiment of the present disclosure;

FIG. 2C is example steps of using the device for sensing and analyzing data, in accordance with an embodiment of the present disclosure; and

FIG. 3 illustrates a flowchart depicting steps of a method for collecting and analysing a sample fluid, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides an apparatus for collecting a sample fluid, the apparatus comprising:
a base part comprising:
   a sample well plate comprising a cavity having a one or more of holes fluidically connecting an inner side of the cavity and an outer side of the cavity (which the outer side is) opposite to the inner side of the cavity, when in use the cavity is configured to receive a sample fluid on the inner side of the cavity;
   a microfluidic plate configured to channelize a flow of at least a part of the sample fluid received via the one or more of holes towards at least one sensor coupled to the microfluidic plate; and
   a plurality of electrical connectors connected to the at least one sensor; and
a lid part coupled to the base part, the lid part comprising a compressible region, the compressible region is configured to receive a first amount of external force thereon and exert a pressure over the sample collection part to enable the flow of at least a part of the sample fluid towards the at least one sensor via the one or more holes and the microfluid plate.

Optionally the apparatus further comprises one or more of dedicated channels to guide reagents into the at least one sensor. Optionally the apparatus might comprise one or more of reagent storages, such as ampoules, in mechanical connection to aforementioned external force, in order to be squeezed in planned order to create phased chemical reaction(s).

In another aspect, an embodiment of the present disclosure seeks to provide a device for sensing and analyzing data from a collected sample fluid, the device comprising:
a first part having a plurality of base connectors, arranged on an inner side of the first part, to connect with a plurality of electrical connectors of at least one sensor of an apparatus as disclosed above
a second part coupled to the first part, the second part comprising an extruding part, wherein the extruding part is configured to provide a first amount of external force towards the first part when the first part and the second part are moved towards each other for a first amount of distance;
an opening arranged between the first part and the second part to receive the apparatus such that a compressible region of a lid part of the apparatus is configured to receive the first amount of external force of the extruding part when in use; and
a controller configured to obtain an indicator value related to at least one sensor of the apparatus. The indicator value can be reading from the sensor.

In yet another aspect, an embodiment of the present disclosure seeks to provide a method for collecting and analysing a sample fluid, the method comprising:
receiving a sample fluid in a sample well plate of an apparatus from a sample collection part of a sample stick;
delivering at least a part of the sample fluid from the sample well plate towards at least one sensor of the apparatus when a compressible region receives a first amount of external force thereon from an extruding part of a device and exerts a pressure on the received sample fluid; and
obtaining an indicator value related to the at least one sensor.

Optionally the sample fluid can be provided with a sample collection part of a sample stick. In this example the exerted pressure is on the sample collection part. This way the sample collection part releases the sample fluid.

In still another aspect, an embodiment of the present disclosure seeks to provide a computer program product comprising a non-transitory computer-readable storage medium having computer-readable instructions stored thereon, the computer-readable instructions being executable by a computing device comprising a processor to execute the aforementioned method.

The apparatus of the present disclosure aims to be more reliable and efficient for collecting the sample fluid, i.e., a biological material such as saliva, sweat, blood, snot or urine, from a subject by means of a sample collection stick. The apparatus is suitably designed to prevent the sample from being contaminated and/or from leaking from the apparatus. Moreover, the design of the apparatus ensures a controlled flow of the sample to the sensors. The apparatus of the present disclosure is designed to ensure that an adequate amount of the sample fluid is collected via the apparatus to facilitate an accurate and precise sensing and analysis of the sample fluid, when required, using the aforementioned device.

The apparatus comprises the base part and the lid part coupled to the base part. It will be appreciated that the base part and the lid part may in a first configuration (i.e., open) provide an access to an inside of the apparatus and in a second configuration (i.e., closed) prevent an access to the inside of the apparatus. Herein, the base part and the lid part are complimentary to each other. Optionally the apparatus may be in the form of a disc, a sphere or any other polygonal shape when the base part and the lid part are arranged in the second configuration. In this regard, the base part is a planar structure having an inner side and an outer side that is opposite the inner side, where a circumferential boundary wall of a predefined height is present around the inner side of the base part. Moreover, a circumferential boundary wall of the lid part couples with the circumferential boundary wall of base part to close or seal the apparatus.

Herein, the term “base part” refers to a supporting part (or component) of the apparatus that is configured to contain various sub-components of the apparatus that are required for the collection of the sample fluid and the subsequent sensing of data from the collected sample fluid. Herein, the term “lid part” refers to a cover part (or component) of the apparatus that is configured to temporarily provide access to or to close or seal a top portion of the base part according to the application of the apparatus. In this regard, the lid part is configured to completely close or seal the base part when the apparatus is either not in use or when the base part accommodates the sample fluid therein, thereby preventing the sample fluid from being contaminated or leaking from the apparatus. A technical effect of having the lid part to close the base part that is configured for analyzing the sample fluid or analyte can contribute to the functionality and reliability of the analytical system enclosed by the apparatus. In this regard, the lid provides a physical barrier that helps to prevent contamination (from airborne particles, dust, and potential interactions with the external environment) of the sample fluid or analyte, thereby, eliminating a potential inaccuracy of the analysis. Additionally, the lid provides an extra layer of safety by preventing an accidental exposure of the sample fluid containing a potentially hazardous or toxic substance therein to the operator and reducing the risk of chemical exposure. Moreover, the lid helps minimizing a potential evaporation of a volatile sample fluid by creating a sealed environment, thus maintaining the original concentration of the sample fluid for obtaining accurate analysis results. Moreover, the lid can block out light and shield the sample fluid from any potential photochemical reactions. Furthermore, the lid helps in regulating the temperature and stabilizing other conditions (such as gas exchange) within the apparatus, by reducing the variability caused by external factors, leading to more reproducible results. Additionally, beneficially, the lid is designed to be easily opened and closed, facilitating convenient loading and unloading of sample fluid, and enhancing the user-friendliness of the apparatus. Additionally, beneficially, the technical effect obtained by the coupling of the lid part with the base part is that the pressure generation is more cost-effective in said design.

Optionally, the lid part is at least partially coupled to the base part with a hinge. Herein, the at least partial coupling of the lid part to the base part with the hinge enables the lid part to close or seal the base part in a pivoting mechanism.

Optionally the sample fluid is delivered using a sample collection part of a sample stick which is accommodated in the cavity when in use. A benefit of this is to avoid contamination of the sample as a person taking a sample holds the stick remotely from sample collection part of the stick.

The base part comprises the sample well plate comprising the cavity having the one or more of holes fluidically connecting an inner side of the cavity and an outer side of the cavity, which the outer side is opposite to the inner side of the cavity, the cavity is configured to receive a sample fluid on the inner side of the cavity. As an example, the sample fluid can be provided directly to the inner side of the cavity (such as splitting, urinating, etc.). Alternatively, the inner side of the cavity can be configured to accommodate a sample collection part of a sample stick. The sample stick can be constructed as of porous the sample collection part arranged in tip of elongated stick. Herein, the term “sample well plate” refers to a plate (flat or planar structure) arranged on a top surface of the inner side of the base part for receiving the sample fluid inside the base part. Specifically, the cavity having one or more of holes is configured to receive the sample fluid collected from the subject. Herein, the term “cavity” refers to a depression arranged at least partly in the sample well plate such that the inner side of the cavity corresponds to the top surface of the inner side of the base part and the outer side of the cavity is opposite the inner side of the cavity. Optionally, the cavity may be arranged in the centre of the sample well plate. Moreover, the inner side of the cavity is fluidically connected to the outer side of the cavity via the one or more of holes for ensuring that the sample fluid is able to flow from the inner side of the cavity to the outer side of the cavity. Optionally the fluidical connection via the plurality of holes may resemble the working of a sieve.

In one embodiment the sample fluid is collected using the sample collection part of the sample stick. Herein, the term “sample stick” refers to an elongate tool or instrument for collecting the sample fluid from the subject. Specifically, the sample collection part, arranged at a proximal end of the sample stick, is used to collect and temporarily store the sample fluid. Therefore, only the sample collection part of the sample stick is accommodated inside the apparatus such that the sample collection part snuggly fits into the cavity of the sample well plate to transfer at least a part of the sample fluid to the cavity, while the rest of the sample stick protrudes out of the apparatus.

Optionally, the sample collection part of the sample stick is made of a soft, porous tissue. Notably, the soft, porous tissue allows greater absorption of the sample fluid and subsequently allow at least a part of the sample fluid to be extracted therefrom when the sample collection part is subjected to compressed under influence of an external pressure. Moreover, the soft, porous tissue may be biocompatible, thus allowing the sample collection part to be safe for being contacted with sensitive parts, such as the mouth, the nose, the ear, and so forth, of the subject's body for collecting the sample fluid.

Moreover, the base part comprises a microfluidic plate configured to channelize a flow of the at least a part of the sample fluid received via the plurality of holes towards at least one sensor coupled to the microfluidic plate. Herein, the term “microfluidic plate” refers to a plate, fluidically connected to the second side of the cavity, via microfluidic channels that are configured to channelize the flow of the sample fluid to from one region (i.e., the cavity) to another region (i.e., the at least one sensor).

Herein, the term “sensor” refers to a device configured to sense data related to a certain physical, electrical, biological, or chemical property. In this regard, the at least one sensor has at least one opening and the at least a part of the sample fluid that is channelized to the at least one sensor is received via said at least one opening. It will be appreciated that the at least one sensor is activated when the sample fluid from the microfluidic channel contacts or penetrates into the at least one sensor. Further, there may be an arrangement of fluidic channels dedicated to deliver reagents helping to perform a chemical reaction or washing in the sensor. In accordance, the chemicals may be stored in breakable or squeezable form within the disc or delivered outside of the disc.

Optionally, the at least one sensor is arranged on any of: the microfluidic plate, the inner side of the base part or the outer side of the base part. In this regard, the at least one sensor may be coupled directly to the ends of the microfluidic channels present in the microfluidic plate. Alternatively, the at least one sensor may be present on the inner side or the outer side of the base part and the microfluidic plate is placed on top of a layer comprising the at least one sensor, and the sample fluid is channelized to the at least one sensor through the microfluidic plate. Optionally, when the number of sensors is more than two, the sensors are arranged in a ring-like pattern or any other suitable pattern corresponding to a pattern of the microfluidic channels of the microfluidic plate. Further optionally the at least sensor can be arranged as combination of the microfluid plate and the inner side of the base part.

Optionally, the apparatus further comprises a filter having a first side and a second side, opposite the first side, arranged to contact the outer side of the cavity and the microfluidic plate, respectively, the filter is configured to control the flow of at least a part of the sample fluid received via the one or more of holes towards the microfluidic plate. Herein, the term “filter” refers to a porous material that allows the sample fluid to pass through it selectively when the apparatus is intended to be used and further prevents any solid particle or contamination in the sample fluid from flowing from the plurality of holes in the cavity towards the microfluidic plate and consequently to the at least one sensor. Moreover, the filter ensures that the sample fluid is evenly spread to the microfluidic plate and consequently to the at least one sensor.

Optionally, the filter is selected from a group of a fiber filter, a fiberglass filter, a natural porous material, a natural fiber material, a synthetic porous material or a synthetic fiber material and wherein the filter comprises a chemical to control the flow of at least a part of the sample fluid. Notably, the fiber filter, the fiberglass filter, and other suitable filters are highly porous with a very small pore size ranging from 15-100 micrometers (μm) that can filter out smaller particles. Optionally, the chemical may be in the form of a soap solution or any other suitable chemical that can control the flow of at least a part of the sample fluid, i.e., the sample fluid does not too early or accidentally penetrates the microfluidic channels. Beneficially, the chemical makes saliva more reactive or otherwise more suitable for analysis.

Furthermore, the base part comprises a plurality of electrical connectors connected to the at least one sensor. Herein, the term “electrical connectors” refers to the wiring configurations configured to transmit electrical signals, from an external electrical source, to the at least one sensor. The plurality of electrical connectors are installed to power the at least one sensor, thus, enabling the at least one sensor to carry out its function of sensing and data collection. The plurality of electrical connectors connected to the at least one sensor enables the sensed data from the at least one sensor to be subsequently analyzed. Optionally, the plurality of electrical connectors are arranged on the outer side of the base part.

Furthermore, the lid part comprises the compressible region, the compressible region is configured to receive the first amount of external force thereon and exert the pressure over the sample collection part to enable the flow of at least a part of the sample fluid towards the at least one sensor. Herein, the term “compressible region” refers to a region in the lid part that is configured to be compressed temporarily from its original position. In this regard, the compressible region is arranged in the lid part such that the position of the compressible region is relatively aligned with the sample collection part received in the cavity of the sample well plate in the base part. Subsequently, whenever the compressible region receives the first amount of external force, the compressible region exerts the pressure over the sample collection part, thus, squeezing the sample collection part to enable the flow of at least a part of the sample fluid towards the at least one sensor via the plurality of holes and the microfluidic plate (and optionally the filter). This way the sample fluid is collected. The collected sample fluid (its composition, chemicals, etc.) can be then sensed with the sensor. Data from the sensor can be then further analyzed to find for example indication of state of well-being of user providing the sample fluid. Optionally, the compressible part reverts back to its original position, upon removal of the first amount of external force thereon, thus making the apparatus ready for use again. Alternatively, optionally, the apparatus is suitable for single (one-time per sample) use only.

A technical effect of having the compressible region arranged with the lid part configured to squeeze a volume of sample fluid for analysis is that said design can significantly impact the way the sample fluid is processed and analysed. Beneficially, the compressible region, when engaged, can exert pressure on the sample fluid, promoting thorough mixing of components within the sample (especially samples with non-uniform distributions, such as emulsions or suspensions having multiple phases or layers) for accurate analysis. Furthermore, the compressible region is configured for creating necessary pressure conditions, leading to efficient sample fluid processing and analysis. Additionally, the compressible region can ensure that every last drop of the samples with limited volumes or precious analytes, is extracted and analysed, maximizing the yield of valuable data.

Optionally, the compressible region is made of an elastic material selected from a group of a plastic material, a silicone material, a rubber material. Herein, any of the plastic material, the silicone material or the rubber material provides an elastic property to the compressible region. Moreover, it will be appreciated that the plastic material, the silicone material or the rubber material is an inert material that is non-reactive with the sample fluid and any of the aforementioned components of the apparatus.

Optionally the apparatus further comprises a chemical container arranged on the cavity between the inner side of the cavity and the compressible region of the lid part, wherein the chemical container is configured to break if the first amount of external force exceeds predefined breaking value. Herein, the term “chemical container” refers to a container carrying a suitable chemical, such as a soap solution or any other suitable chemical, that is released to the sample collection part of the sample stick when the chemical container is broken due to the first amount of external force being applied exceeds the predefined breaking value, to control the flow of the sample fluid towards the at least one sensor. It will be appreciated that the predefined breaking value may be equal to or higher than the first amount of external force. Optionally, the contents of the chemical container might be delivered to the sensors without contact with the sample fluid. For example, a chemical in the chemical container can be Ferrocyanide. The Ferrocyanide is meant to act as redox-agent (binding to antigen) after all previous chemical reactions with sample fluid and sensor chemistry have taken place. In further optional embodiment, the sensor surface is dry or actively dried before the chemical container contents pours into the sensor.

Optionally, the plurality of holes is arranged to prevent the flow of at least a part of the sample fluid if no pressure is exerted over the sample collection part. In this regard, the plurality of holes may comprise a breakable seal or film over it to prevent the sample fluid from leaving the sample collection part when no pressure is exerted over the sample collection part.

Optionally, the apparatus further comprises a locking mechanism arranged opposite to the hinge, and wherein the locking mechanism is arranged in a manner to enable accommodation of the sample collection part in the base part. Herein, the term “locking mechanism” refers to closing mechanism that is used to facilitate the opening and closing of the lid part over the base part. Optionally, the locking mechanism may be in the form of a first tab and a second tab associated with the base part and the lid part, respectively. Alternatively, optionally, the locking mechanism may be in the form of a snap-fit mechanism or a screw cap mechanism. Beneficially, the locking mechanism implemented as the first tab and the second tab enables easy opening and closing of the apparatus without contaminating or spilling the sample fluid for analysis, when the apparatus is in use or is intended for use.

Optionally, the apparatus further comprises an identification code selected from a group of a quick response (QR) code, a Radio Frequency Identification (RFID) code, a barcode. Herein, the term “identification tag” refers to a tag that is used for identifying an authenticity of the apparatus, thus ensuring that an unauthentic or a low-quality apparatus is not being used. Optionally, the identification code may be provided at the base part of the apparatus, specifically at the outer side of the base part.

Moreover, the present disclosure also relates to the device as described above. Various embodiments and variants disclosed above apply mutatis mutandis to the device.

The device is used for analyzing the sensor data obtained from the at least one sensor of the aforementioned apparatus. The device comprises the first part having the plurality of base connectors, arranged on the inner side of the first part, to connect with the plurality of electrical connectors of the at least one sensor of the apparatus. Herein, the term “first part” refers to a hollow part having an inner side and an outer side, where the inner side of the first part has the plurality of base connectors therein. Herein, the term “base connectors”, similar to the electrical connectors, refers to wiring configurations configured to connect with the complementary plurality of electrical connectors of the at least one sensor, thus allowing the device to receive sensed data of the at least one sensor from the apparatus. In this regard, the received sensed data is used by the device for further analysis.

Moreover, the device comprises a second part coupled to the first part. Herein, the second part comprises an inner side and an outer side, opposite to the inner side, wherein the inner side of the second part faces the inner side of the first part when the second part is coupled to the first part. It will be appreciated that a second boundary wall of the second part is able to move nearer to and farther from a first boundary wall of the first part when the second part and the first part are brought closer together to obtain a first direction (i.e. closed configuration) or moved apart in a second direction (i.e. opened configuration).

Moreover, the second part comprises the extruding part, wherein the extruding part is configured to provide the first amount of external force towards the first part when the first part and the second part are moved towards each other for the first amount of distance. Herein, the term “extruding part” refers to a part having a defined shape and thickness and is extruding out from the first side of the second part in a specific direction, i.e., towards the inner side of the first part. Subsequently, when the first part and the second part are moved towards each other for the first amount of distance, i.e., the second boundary wall of the second part moves nearer to the first boundary wall of the first part by a fixed distance, then the extruding part is configured to provide a first amount of external force towards the first part, as the extruding part is extruding towards the inner side of the first part.

Optionally, the extruding part is coupled to the second part with a spring, the spring being arranged to press the extruding part towards the first part with the first amount of external force when the second part is moved the first amount of distance. Herein, coupling the extruding part to the second part with the spring, allows the extruding part to have a contracting and relaxing motion thus allowing the extruding part to be pressed towards the first part with the first amount of external force on moving the second part by the first amount of distance.

Optionally, the extruding part is coupled to the second part with a spring, the spring being arranged to press the extruding part towards the first part with the second amount of external force when the second part is moved the second amount of distance. Similarly, the extruding part is pressed towards the first part with the second amount of external force on moving the second part by the second amount. Herein the second amount of distance is different from the first amount of distance.

Optionally, the first part and the second part are rotatable relative to each other, and wherein a rotational movement of the first part relative to the second part in a first direction causes the extruding part to provide the first amount of external force towards the compressible region when in use. In this regard, the movement of the first boundary wall of the first part relative to the second boundary wall of the second part is in the form of a rotational movement (such as twisting relative to each other) resulting in the first boundary wall and the second boundary wall to come nearer or farther to each other based on the direction of rotation of the first part relative to the second part. Specifically, the rotational movement of the first part relative to the second part in the first direction and a second direction causes the first part and the second part to move nearer to or farther away from each other, respectively.

Alternatively, optionally, the first part and the second part are movable laterally relative to each other. In this regard, the movement of the first boundary wall of the first part relative to the second boundary wall of the second part is in the form of a lateral movement. Herein, the lateral movement of the first part relative to the second part in the first direction and the second direction causes the first part and the second part to move nearer to or farther away from each other, respectively.

Moreover, the device comprises the opening arranged between the first part and the second part to receive the apparatus such that the compressible region of the lid part of the apparatus is configured to receive the first amount of external force of the extruding part when in use. The opening may receive the apparatus by sliding or placing the apparatus therein. When the apparatus is received in the opening, the first boundary wall is completely attached to the second boundary wall for using the device and the apparatus for analysis of the sample fluid in the apparatus. In this regard, the apparatus is received in the opening such that the compressible region of the lid part of the apparatus faces the extruding part and the base part of the apparatus sits against the first part of the device such that the plurality of electrical connectors contact the plurality of base connectors. It will be appreciated that upon receiving the apparatus via the opening, when the first boundary wall and the second boundary wall are made to move nearer to each other, the apparatus consequently receives the first amount of external force of the extruding part on the compressible region of the lid part of the apparatus.

Optionally, the compressible region is configured to receive the first amount of external force thereon from the extruding part and exert a pressure on a sample collection part of a sample stick to enable a flow of at least a part of the sample fluid towards the at least one sensor. The first amount of external force exceeds a predefined threshold required for enabling the flow of at least a part of the sample fluid in the apparatus towards at least one sensor through the plurality of holes of the cavity and the microfluidic channels of the microfluidic plate, for sensing of data corresponding to the sample fluid. Optionally, the extruding part may be made of a soft substance like a rubber, thus ensuring that the extruding part does not cause any permanent damage to the compressible region of the apparatus, thereby allowing for a potential reuse of the apparatus, if required.

A technical effect of receiving the first amount of external force by the compressible region from the extruding part is that the extruding part is configured to provide a predetermined pressure that is sufficient for controlling the flow of at least a part of the sample fluid in the apparatus. Beneficially, when the apparatus is received in the device and the first part and the second part of the device are laterally twisted or slid against each other, the external force (pressure) is exerted on the compressible region of the apparatus allowing for controlled compression of the sample fluid within the apparatus. This controlled compression imparts similar pressure and motion thereby reducing variability in sample preparation across different users. Additionally, the lateral twisting motion applied to the device (or the receiving unit of the apparatus) ensures a more even and uniform distribution of pressure across the compressible region for efficient mixing of components within the sample fluid, and consistent and reproducible results in sample fluid processing. Moreover, the lateral twisting motion can be designed to be ergonomic and user-friendly, making the operation of the device and apparatus intuitive and efficient. Furthermore, the combination of the compressible region and lateral twisting action on the device can potentially be automated, leading to consistent and reproducible sample processing in automated analytical systems.

It will be appreciated that such use of two separate units, i.e., the apparatus for analysis of the sample fluid and the device for pressurizing the apparatus, imparts operational flexibility, efficiency, and accuracy of sample fluid analysis, for example, elimination of frequent contact to the apparatus and thus preventing potential contamination thereof, and ensuring that the sample fluid conditions remain consistent throughout the analysis and are not affected by a potential pressure change (contrary to when conventional pressurizing systems are employed). Moreover, it ensures multiple uses of the device and apparatus for one or more patients, for example, while one analysis is being conducted, the pressurizing unit can prepare the next sample fluid, optimizing throughput and productivity, and minimizing downtime for the overall system. Moreover, a dedicated pressurizing unit can be designed to be compatible with various analytical methods or techniques, making it a versatile tool for different applications.

Moreover, the device comprises a controller configured to obtain an indicator value related to at least one sensor of the apparatus. Herein, the term “controller” refers to a computing part present in the device having processing capabilities. Optionally, the controllers include but is not limited to, a microcontroller, a processor, a microprocessor, a complex instruction set computing (CISC) microprocessor, a reduced instruction set (RISC) microprocessor, a very long instruction word (VLIW) microprocessor, Field Programmable Gate Array (FPGA) or any other type of controlling circuit, for example as aforementioned. In essence, the plurality of base connectors is coupled with the controller. The controller is configured to provide, via the plurality of base connectors, electrical signals to the at least one sensor via the plurality of electrical connectors, and in turn receive a related electrical signal from the at least one sensor via the plurality of base connectors. Herein, the term “related electrical signal” may preferably relate to signals corresponding to the change in electrical characters measured as the function of a data of a certain property, such as an amount of at least one molecule of interest in the sample fluid, by the at least one sensor. Notably, the related electrical signal is in a form readable by the controller. Herein, the term “indicator value” refers to a numerical value giving a certain indication related to the data of the certain property, such as the amount of the at least one molecule of interest in the sample fluid, which is being sensed by the at least one sensor.

Subsequently, the controller uses the received indicator values for further analysis and for drawing out certain inferences related to the certain property of the sample fluid sensed by the at least one sensor. Optionally, the device further comprises a memory unit to store data corresponding to the received indicator value related to the at least one sensor, data received from the at least one sensor, and so forth.

Optionally, the device is configured to attain a plurality of modes of operation selected from:
an inactive mode,
a feed mode having the first part and the second part arranged to provide the opening to receive the apparatus therein; and
an analysis mode having the second part configured to move the first amount of distance relative to the first part to provide the first amount of external force on the compressible region of the lid part of the apparatus.

In this regard, the term “inactive mode” refers to a resting mode in which the device is not in use and the first boundary wall of the first part is attached to the second boundary wall of the second part such that there is no opening between the first part and the second part. It will be appreciated that having the first boundary wall and the second boundary wall attached together prevents inner components of the device, such as the plurality of base connectors and the extruding part, from being contaminated or lose their effectiveness due to moisture, dirt and such other factors. Herein, the term “feed mode” refers to a first active mode in which the first boundary wall of the first part is moved farther away from the second boundary wall of the second part, thus arranging (namely, creating) the opening between the first part and the second part for receiving the apparatus in the device for analysis of the sample fluid in the apparatus. Herein, the term “analysis mode” refers to a second active mode where the first boundary wall of the first part and the second boundary wall of the second part are made to move nearer to each other by the first amount of distance so that the extruding part of the second part of the device exerts the first amount of external pressure on the compressible region of the lid part of the apparatus thus allowing the flow of at least a part of the sample fluid from the sample collection part to the at least one sensor, in order for the sensor to sense the data of the certain property and the provide related electrical signal to the controller for further analysis thereof. An example of analyzing data associated with collected sample fluid is finding amount of hormones in the sample.

Optionally, the device is configured to report the current mode of operation via at least one of: an LED module, a haptic module, or an acoustic module. Optionally, an LED module may be provided on the device, such as on the outer side of the first part or the second part of the device, to communicate the current mode of operation of the device to the user. In this regard, the signal is a light signal that changes from one color (such as yellow) to another (such as red) based on the processing of the sample fluid in the apparatus, i.e., by the at least one sensor, and in the device. Herein, for example the ‘yellow’ color light signals the inactive mode, the ‘orange’ color light signals the feed mode and the ‘green’ color light signals the analysis mode. It will be appreciated that the user may be associated with a user device, such as a smart phone, a laptop, or a server.

A technical effect of using different colour light indicators, or haptic or acoustic signals to indicate different mode of operations of the apparatus is that it enhances the functionality, user experience (by offering customization options for indicating modes), and safety of the apparatus. Particularly, different coloured lights, haptic feedback (vibrations or tactile sensations), or acoustic signals provide a clear and intuitive way to communicate to the user the current mode of operation. This reduces confusion and the risk of errors caused by misunderstanding the status of the apparatus. Moreover, in cases where the apparatus can be monitored remotely, different colored lights or auditory signals can provide real-time feedback to remote operators about the apparatus's current mode and status, for example in emergency or error situations. Furthermore, incorporating haptic and acoustic signals provides information to users who may have visual impairments, thus, making the apparatus more inclusive and usable by a wider range of individuals.

Optionally, the device further comprises a communication interface configured to provide the indicator value to a computing unit, wherein the computing unit is configured to analyse the indicator value to determine a significance of the amount of the at least one molecule of interest in the sample fluid. Herein, the term “computing unit” refers to a unit having processing capabilities. Optionally, the computing unit may be a cloud server, a database or a processor. The reader part may transfer the information received from the at least one sensor to the computing device for further processing and analysis of the information. Optionally, the computing unit may include, but is not limited to, cellular phones, personal digital assistants (PDAs), handheld devices, wireless modems, laptop computers, personal computers, and so forth.

Notably, the computing unit receives the indicator value from the device over the communication interface established between the device and the computing unit. Subsequently, the computing unit further analyses the indicator value in order to determine the significance of the amount of the at least one molecule of interest in the sample fluid. Herein, the significance of the amount corresponds to an implication of the particular amount of the at least one molecule of interest in the sample fluid. Herein, the term “communication interface” refers to a means of communication that is used to communicate the indicator value to the computing unit. Optionally, the communication interface may be a wired or a wireless communication unit. Optionally, the communication interface may include, but is not limited to, Bluetooth®, Wireless Fidelity (Wi-Fi), Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, fifth generation (5G) telecommunication networks and Worldwide Interoperability for Microwave Access (WiMAx) networks.

Optionally, the device further comprises a chemical addition mode, wherein the second part is configured to move, additionally to the first amount of distance, a second amount of distance relative to the first part to provide a second amount of external force on the compressible region of the lid part of the apparatus. Herein, the term “chemical addition mode” refers to a mode wherein the second part is further moved by the second amount of distance in addition to the first amount of distance, thus allowing the extruding part to exert the second amount of force on the compressible region of the lid part of the apparatus which exceeds the predefined breaking value of the chemical container present in the container and thus breaking the chemical container to release the chemical to the sample collection part of the sample stick accommodated in the apparatus, thereby controlling the flow of the at least a part of the sample fluid towards the at least one sensor.

Optionally, the device further comprises an identification scanner to validate authenticity of the apparatus. Herein, the term “identification scanner” refers to a scanner present in the device, such as at the first part of the device, that performs the scanning of the identification tag present in the apparatus and thus, validates authenticity of the apparatus being used. Herein the identification scanner is capable of scanning the RFID tag, the QR-code, the bar code or any other form of identification tag associated with the apparatus. It will be appreciated that the identification scanner may be arranged on the inner side of the first part of device such that when the apparatus is received in the device, the identification scanner corresponds to the identification code provided at the outer side of the base part of the apparatus.

Optionally, the device further comprises a charger for charging the device. Herein, the device may be configured to be charged from an external power source or an internal power source, such as a battery unit. In case of an internal battery unit, the internal battery unit may have a certain battery life and once the device is used for a time period the battery life exhausts, then the device may again be recharged for further use via the charger. Herein, the charger may be a magnetic charger or a wired charger. Optionally, the device may be charged when the device is in inactive mode.

Moreover, the present disclosure also relates to the method as described above. Various embodiments and variants disclosed above apply mutatis mutandis to the method.

Optionally, the method further comprises providing a first amount of external force on the compressible region from the extruding part when a first part and a second part of the device are rotatable relative to each other in a first direction for a first amount of rotation.

Optionally, the method further comprises providing a second amount of external force on the compressible region from the extruding part when the first part and the second part of the device are rotatable relative to each other in the first direction for a second amount of rotation.

Optionally, a chemical is released to the sample collection part of the sample stick when the compressible region receives the second amount of external force thereon from an extruding part of the device, wherein the second amount of external force is higher than the first amount of external force.

Optionally, the method further comprises providing, via a communication interface, the indicator value to a computing unit, wherein the computing unit is configured to analyse the indicator value to determine a significance of the amount of the at least one molecule in the sample fluid.

Moreover, the present disclosure also relates to the computer program product as described above. Various embodiments and variants disclosed above apply mutatis mutandis to the computer program product.

Optionally, the computer program product is implemented as an algorithm, embedded in a software stored in the non-transitory computer-readable storage medium. The non-transitory computer-readable storage medium may include, but is not limited to, an electronic storage device, a magnetic storage device, an optical storage device, an electromagnetic storage device, a semiconductor storage device, or any suitable combination of the foregoing. Examples of implementation of computer-readable storage medium, but are not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory.

Indeed, the device can be used to sense for example hormones from a sample fluid (of saliva for example). The sensed hormone level is in practice data such as mol/liter of certain hormone. This data can be analyzed for example to find condition (of person) related to the hormone.

### DETAILED DESCRIPTION OF DRAWINGS

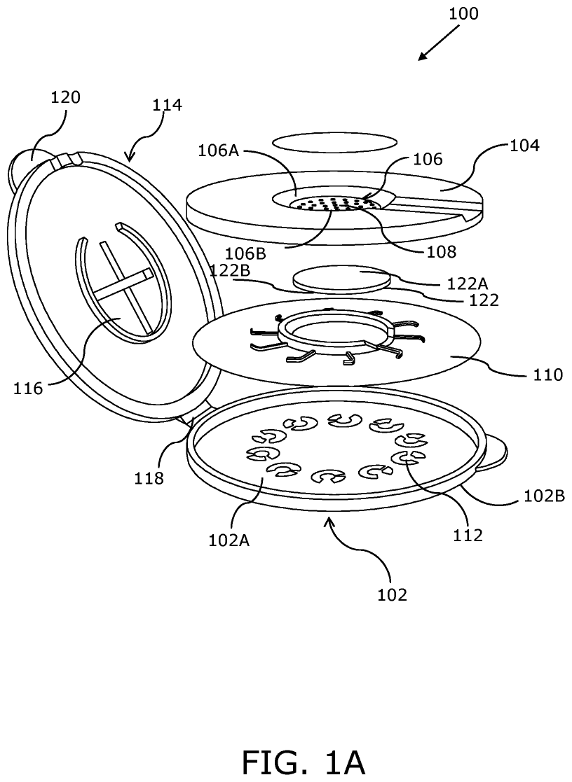

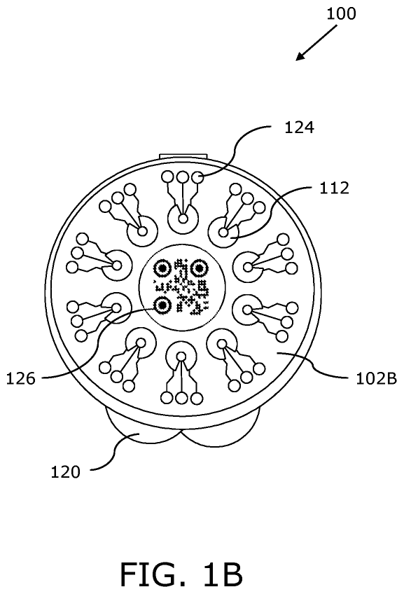

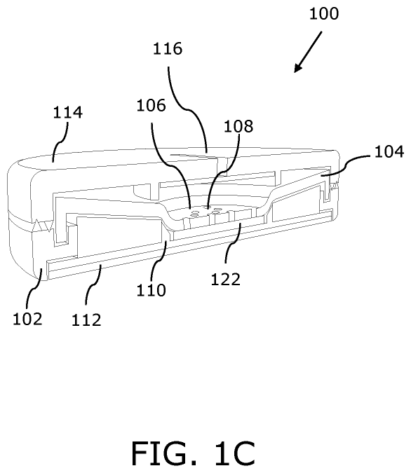

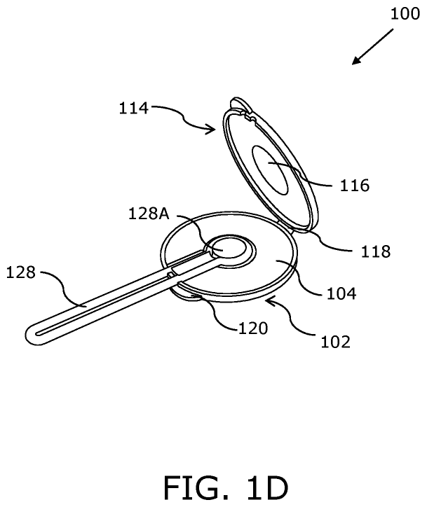

Referring to FIG. 1A, there is shown an exploded view of an apparatus 100 for collecting a sample fluid in an open configuration thereof, in accordance with an embodiment of the present disclosure. As shown, the apparatus 100 comprises a base part 102 having an inner side 102A and an outer side 10213. As shown, the base part 102 comprises a sample well plate 104 comprising a cavity 106 having one or more of holes 108. The one or more holes fluidically connects an inner side 106A of the cavity 106 and an outer side 10613 of the cavity. (in the FIG. 1A the inner side 106A is illustrated to face upwards and the outer side 10613 is illustrated to face downwards. Moreover, the base part 102 comprises a microfluidic plate 110 configured to channelize a flow of at least a part of the sample fluid received via the one or more of holes 108 towards at least one sensor 112 coupled the microfluidic plate 110. Moreover, the apparatus 100 comprises a lid part 114 coupled to the base part 102. Optionally, the lid part 114 may be at least partially coupled to the base part 102 with a hinge 118. As shown, the lid part 114 comprises a compressible region 116. Optionally, the lid part 114 is at least partly coupled to the base part 102 via a hinge 118. Optionally, the apparatus 100 comprises a locking mechanism 122 arranged opposite to the hinge 118. When in use, the cavity 106 is configured to receive a sample fluid on the inner side 106A of the cavity 106. Alternatively, the sample fluid can be provided using a sample stick (not shown in FIG. 1A).

Optionally, the apparatus 100 may comprise a filter 122 having a first side 122A and a second side 122A, opposite the first side 122A. The second side is arranged to contact the outer side 10613 of the cavity 106 and the first side 122B microfluidic plate 110, respectively.

Referring to FIG. 1B, there is shown a bottom view of the apparatus 100 for collecting the sample fluid in a closed configuration thereof, in accordance with an embodiment of the present disclosure. Herein, the base part 102 comprises a plurality of electrical connectors 124, connected to the at least one sensor 112. Optionally, the apparatus 100 further comprises an identification code 126. As shown, the identification code 126 is implemented as a quick response (QR) code.

Referring to FIG. 1C, there is shown a cross-sectional view of the apparatus 100 for collecting the sample fluid in a closed configuration thereof, in accordance with an embodiment of the present disclosure. As shown, the lid part 114 closes the base part 102 to protect inner components (such as the sample well plate 104, the cavity 106, the one or more of holes 108, the microfluidic plate 110, the at least one sensor 112, the compressible region 116 and the filter 122) and the sample fluid from a potential contamination.

Referring to FIG. 1D, there is shown a perspective view of accommodating a sample stick 128 in the apparatus 100 for collecting the sample fluid, in accordance with an embodiment of the present disclosure. As shown, a sample collection part 128A of the sample stick 128 is accommodated in the cavity of the sample well plate 104 of the apparatus 100.

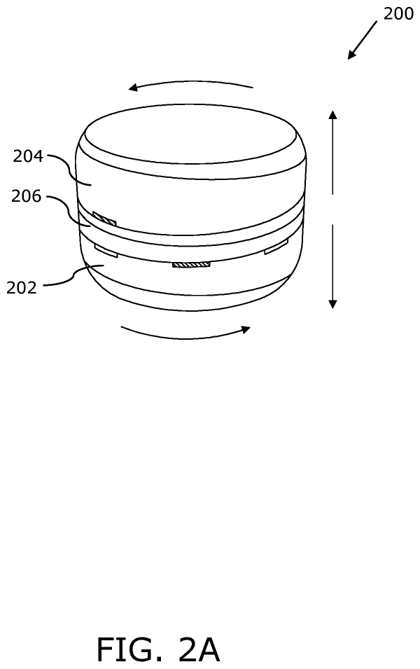

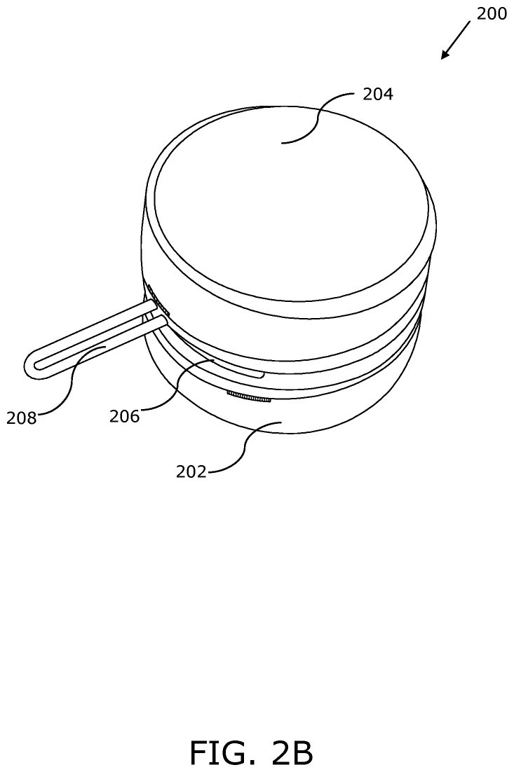

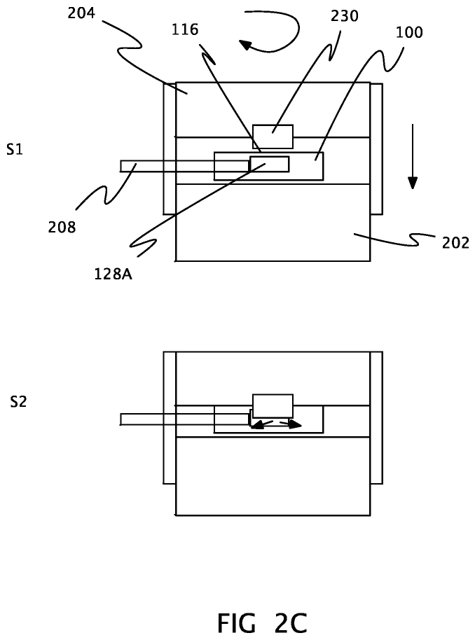

Referring to FIG. 2A, there is shown a perspective view of a device 200 for sensing and analysing data from a collected sample fluid in an inactive mode thereof, in accordance with an embodiment of the present disclosure. As shown, the device 200 comprises a first part 202 and a second part 204 coupled to the first part 202. The first part 202 has a plurality of base connectors, arranged on an inner side of the first part, to connect with a plurality of electrical connectors (such as the electrical connector 124 of FIG. 1B) of at least one sensor (such as the sensor 112 of FIG. 1A) of an apparatus (such as the apparatus 100 of FIG. 1A). Moreover, the second part comprises an extruding part, wherein the extruding part is configured to provide a first amount of external force towards the first part 202 when the first part 202 and the second part 204 are moved towards each other for a first amount of distance. Furthermore, the device 200 comprises an opening 206 arranged between the first part 202 and the second part 204 to receive the apparatus.

Referring to FIG. 2B, there is shown a perspective view of a device 200 for sensing and analysing data from a collected sample fluid in an analysis mode thereof, in accordance with an embodiment of the present disclosure. As shown, the device 200 has received the apparatus along with the sample stick 208 (such as the sample stick 128 of FIG. 1D). When the apparatus along with the sample stick 208 is received in the device 200, a first amount of external force from the extruding part is applied to a compressible region (such as the compressible region 116 of FIG. 1A) of a lid part (such as the lid part 114 of FIG. 1A) of the apparatus to allow at least a part of the sample fluid to flow from a sample collection part (such as the sample collection part 128A of FIG. 1D) of the sample stick 208 towards the at least one sensor.

FIG. 2C is an illustration of step S1 in which the apparatus 100 is arranged inside of the device 200 before sample fluid is extracted from the sample collection part 128A of the sample stick 208. As illustrated compressible region 116 is below the extruding part 230 of the second part 204. The second part is connected to the first part 202 for example using grooves. In step S2 the first part is rotated in respect to the second part thus moving the first part closer to the second part. During said movement the extruding part 230 presses the compressible region 116 of the apparatus 100. The sample collection part 128A thus is applied with a force. The force will push fluids from the sample collection part 128A via one or more holes towards sensor. The sensor reading is then received by electronics of the device and can be thus analyzed.

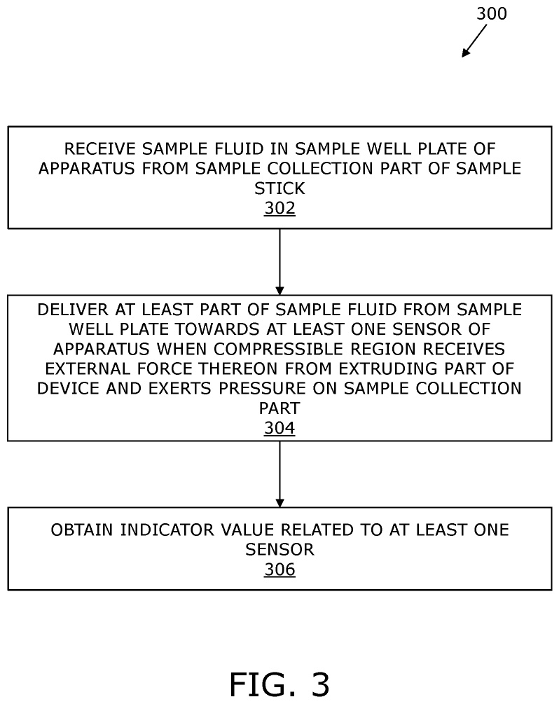

Referring to FIG. 3, there is illustrated a flowchart 300 depicting steps of a method for collecting and analysing a sample fluid, in accordance with an embodiment of the present disclosure. At step 302, a sample fluid is received from a sample collection part of a sample stick in a sample well plate of an apparatus. At step 304, at least a part of the sample fluid from the sample well plate is delivered towards at least one sensor of the apparatus, when a compressible region receives a first amount of external force thereon from an extruding part of a device and exerts a pressure on the sample collection part. At step 306, an indicator value related to the at least one sensor is obtained.

The steps 302, 304 and 306 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Expressions such as “may” and “can” are used to indicate optional features, unless indicated otherwise in the foregoing. Reference to the singular is also to be construed to relate to the plural.

1. An apparatus for collecting a sample fluid, the apparatus comprising:
a base part comprising:
a sample well plate comprising a cavity having one or more of holes fluidically connecting an inner side of the cavity and an outer side of the cavity opposite the inner side of the cavity, when in use the cavity is configured to receive a sample fluid on the inner side of the cavity;
a microfluidic plate configured to channelize a flow of at least a part of the sample fluid received via the one or more of holes towards at least one sensor (112) coupled to the microfluidic plate; and
a plurality of electrical connectors connected to the at least one sensor; and
a lid part coupled to the base part, the lid part comprising a compressible region, the compressible region is configured to receive a first amount of external force thereon and exert a pressure over the received sample fluid to enable the flow of at least a part of the sample fluid towards the at least one sensor via the one or more holes and the microfluid plate.

2. The apparatus according to claim 1, wherein the one or more of holes is arranged to prevent the flow of at least a part of the sample fluid if no pressure is exerted over the sample collection part.

3. The apparatus according to claim 1, wherein the at least one sensor is arranged on any of: the microfluidic plate, an inner side of the base part-, combination of the microfluidic plate and the inner side of the base part or an outer side of the base part.

4. The apparatus according to claim 1, further comprising a filter having a first side and a second side, opposite the first side, arranged to contact the outer side of the cavity and the microfluidic plate, respectively, the filter is configured to control the flow of at least a part of the sample fluid received via the one or more of holes towards the microfluidic plate.

5. The apparatus according to claim 4, wherein the filter is selected from a group of a fiber filter, a fiberglass filter, a natural porous material, a natural fiber material, a synthetic porous material or a synthetic fiber material and wherein the filter comprises a chemical to control the flow of at least a part of the sample fluid.

6. The apparatus according to claim 1, wherein the lid part is at least partially coupled to the base part with a hinge.

7. The apparatus according to claim 1, wherein the sample fluid is delivered using a sample collection part of a sample stick which is accommodated in the cavity when in use.

8. The apparatus according to claim 7, wherein the apparatus comprises a locking mechanism arranged opposite to the hinge—, and wherein the locking mechanism is arranged in a manner to enable accommodation of the sample collection part in the base part.

9. The apparatus according to claim 1, wherein the compressible region is made of an elastic material selected from a group of a plastic material, a silicone material, a rubber material.

10. The apparatus according to claim 1, further comprises an identification code selected from a group of a quick response (QR) code, a Radio Frequency Identification (RFID) code, a barcode.

11. The apparatus according to claim 1, further comprising a chemical container arranged on the cavity between the inner side of the cavity and the compressible region of the lid part, wherein the chemical container is configured to break if the first amount of external force exceeds predefined breaking value.

12. A device for sensing and analyzing data from a collected sample fluid, the device comprising:
a first part having a plurality of base connectors, arranged on an inner side of the first part, to connect with a plurality of electrical connectors of at least one sensor of an apparatus;
a second part coupled to the first part, the second part comprising an extruding part, wherein the extruding part is configured to provide a first amount of external force towards the first part when the first part and the second part are moved towards each other for a first amount of distance;
an opening arranged between the first part and the second part to receive the apparatus such that a compressible region of a lid part of the apparatus is configured to receive the external force of the extruding part when in use; and
a controller configured to obtain an indicator value related to at least one sensor of the apparatus.

13. The device according to claim 12, wherein the first part and the second part are rotatable relative to each other, and wherein a rotational movement of the first part relative to the second part in a first direction causes the extruding part to provide the external force towards the compressible region when in use.

14. The device according to claim 12, wherein the device is configured to attain a plurality of modes of operation selected from:
an inactive mode,
a feed mode having the first part and the second part arranged to provide the opening to receive the apparatus therein; and
an analysis mode having the second part configured to move the first amount of distance relative to the first part to provide the first amount of external force on the compressible region of the lid part of the apparatus.

15. The device according to claim 14, wherein the device further comprises a chemical addition mode, wherein the second part is configured to move, additionally to the first amount of distance, a second amount of distance relative to the first part to provide a second amount of external force on the compressible region of the lid part of the apparatus.

16. The device according to claim 12, further comprising a communication interface configured to provide the indicator value to a computing unit, wherein the computing unit is configured to analyse the indicator value to determine a significance of the amount of the at least one molecule of interest in the sample fluid.

17. The device according to claim 12, wherein the compressible region is configured to receive the external force thereon from the extruding part and exert a pressure on a sample collection part of a sample stick to enable a flow of at least a part of the sample fluid towards the at least one sensor.

18. The device according to claim 12, further comprising an identification scanner to validate authenticity of the apparatus.

19. The device according to claim 12, wherein the extruding part is coupled to the second part with a spring, the spring being arranged to press the extruding part towards the first part with the first amount of external force when the second part is moved the first amount of distance.

20. The device according to claim 12, wherein the extruding part is coupled to the second part with the spring, the spring being arranged to press the extruding part towards the first part with the second amount of external force when the second part is moved the second amount of distance.

21. A method for collecting and analysing a sample fluid, the method comprising:
receiving the sample fluid in a sample well plate of an apparatus;
delivering at least a part of the sample fluid from the sample well plate towards at least one sensor of the apparatus when a compressible region receives a first amount of external force thereon from an extruding part of a device and exerts a pressure on the received sample fluid; and
obtaining an indicator value related to the at least one sensor.

22. A method according to claim 21, the method comprising providing the sample fluid with a sample collection part of a sample stick and exerting the pressure on the sample collection part.

23. The method according to claim 21, further comprising providing the first amount of external force on the compressible region from the extruding part when a first part and a second part of the device are rotatable relative to each other in a first direction for a first amount of rotation.

24. The method according to claim 21—, further comprising providing a second amount of external force on the compressible region from the extruding part when the first part and the second part of the device are rotatable relative to each other in the first direction for a second amount of rotation.

25. The method according to claim 21—, wherein a chemical is released to the sample collection part of the sample stick when the compressible region receives the second amount of external force thereon from an extruding part of the device (200), wherein the second amount of external force is higher than the first amount of external force.

26. The method according to claim 21—, further comprising providing, via a communication interface, the indicator value to a computing unit, wherein the computing unit is configured to analyse the indicator value to determine a significance of the amount of the at least one molecule in the sample fluid.
